(19) United States
(12) Patent Application Publication
(10) Pub. No.: US 2026/0250987 A1
(43) Pub. Date: Aug. 27, 2026

(54) TWO-WAY LINKAGE LOCK AND DEVICE HAVING THE SAME

(71) Applicant: Fulian Precision Electronics (Tianjin) Co., LTD., Tianjin (CN)

(72) Inventor: YEN-LU CHENG, New Taipei (TW)

(21) Appl. No.: 19/191,566

(22) Filed: Apr. 28, 2025

(30) Foreign Application Priority Data
Feb. 24, 2025 (CN) 202520297974.4

(51) Int. Cl. E05B 65/00

(52) U.S. Cl. CPC E05B 65/00

(57) ABSTRACT

A two-way linkage lock includes a connecting rod, a first locking assembly located at an end of the connecting rod, and a second locking assembly. A connecting pin is provided at the end of the connecting rod, the first locking assembly includes a lock head and a first locking tongue sleeved on the lock head. The lock head drives the first locking tongue to rotate, and a sliding groove penetrates the first locking tongue, and the connecting pin extends through the sliding groove and is slidably arranged along the sliding groove, thereby driving the connecting rod to move along an extension direction of the connecting rod. The second locking assembly includes a second locking tongue, the second locking tongue is fixed to an end of the connecting rod away from the first locking assembly. A device having the two-way linkage lock is also provided.

### FIELD

The subject matter herein generally relates to a technical field of anti-theft locks, and in particular to a two-way linkage lock.

### BACKGROUND

Traditional locks can only be fixed in one direction. In large equipment or products with multiple locking requirements, multiple locks are required. When unlocking is required, each lock must be unlocked in turn, which is cumbersome and time-consuming.

Therefore, there is room for improvement within the art.

### BRIEF DESCRIPTION OF THE DRAWINGS

Implementations of the present disclosure will now be described, by way of embodiments, with reference to the attached figures.

FIG. 1 is a structural schematic view of a two-way linkage lock according to an embodiment of the present disclosure.

FIG. 2 is a structural schematic view of a first locking tongue according to an embodiment of the present disclosure.

FIG. 3 is a structural schematic view of a second locking tongue according to an embodiment of the present disclosure.

FIG. 4 is a top view of the two-way linkage lock shown in FIG. 1 in a locked state.

FIG. 5 is a top view of the two-way linkage lock shown in FIG. 1 in an unlocked state.

FIG. 6 is a structural schematic view of a device according to an embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

The term “comprising,” when utilized, means “including, but not necessarily limited to”; it specifically indicates open-ended inclusion or membership in the so-described combination, group, series, and the like.

It can be understood that when describing that two components are arranged in parallel/vertically, the angle between the two components is allowed to have a tolerance of ±10% relative to the standard parallel/vertical.

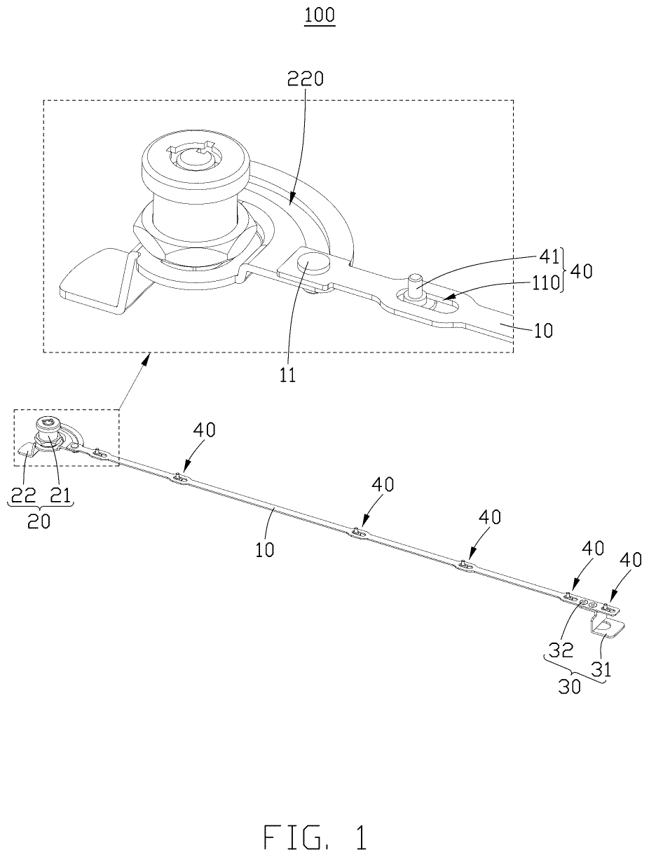

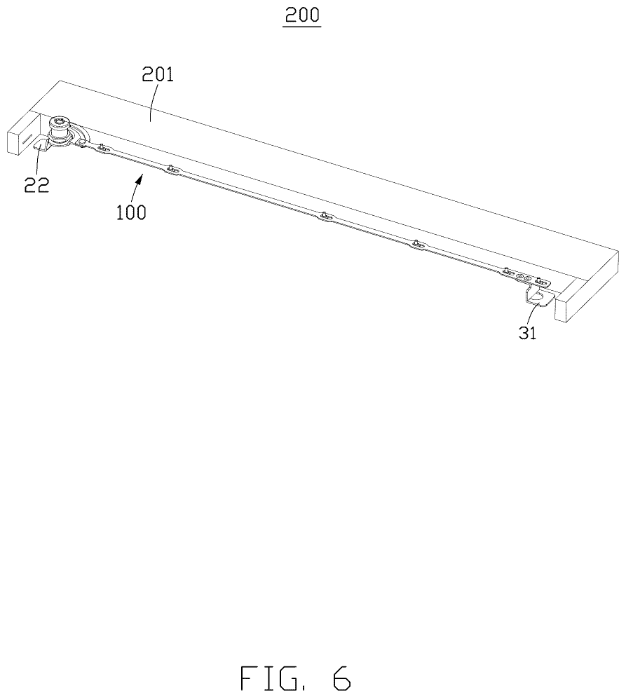

FIG. 1 illustrates an embodiment of a two-way linkage lock 100. Referring to FIGS. 1 to 3, the two-way linkage lock 100 includes a connecting rod 10, a first locking assembly 20 and a second locking assembly 30. The first locking assembly 20 and the second locking assembly 30 are respectively located at both ends of an extension direction of the connecting rod 10. The first locking assembly 20 can be used to lock a certain point of an object 201 (shown in FIG. 6) to be locked, and the second locking assembly 30 can be used to lock another point. A connecting pin 11 is provided at one end of the connecting rod 10, and the first locking assembly 20 is movably connected to the connecting rod 10 through the connecting pin 11. The first locking assembly 20 includes a lock head 21 and a first locking tongue 22 sleeved on the lock head 21. The lock head 21 may be controlled to rotate by a key or other opening method. The first locking tongue 22 may rotate under the drive of the lock head 21, for example, screw in or out of the object to be locked, thereby completing the locking or unlocking action. The first locking tongue 22 is provided with a sliding groove 220 that penetrates the first locking tongue 22 along a thickness direction of the first locking tongue 22. The connecting pin 11 extends through the sliding groove 220 and is slidably arranged along the sliding groove 220, thereby driving the connecting rod 10 to move along the extension direction of the connecting rod 10. The second locking assembly 30 includes a second locking tongue 31, and the second locking tongue 31 is fixed to an end of the connecting rod 10 away from the first locking assembly 20. When the connecting rod 10 moves driven by the first locking tongue 22, the second locking tongue 31 fixed on the connecting rod 10 will also move, and the second locking tongue 31 will extend into or withdraw from the object to be locked, thereby completing the locking or unlocking action synchronously with the first locking tongue 22.

By providing the connecting rod 10 movably connected to the first locking tongue 22 (the connecting rod 10 is movably connected to the first locking tongue 22 through the sliding groove 220 and the connecting pin 11), and providing the second locking tongue 31 on the connecting rod 10, the rotation of the first locking tongue 22 can drive the connecting rod 10 to move, and the movement of the connecting rod 10 can drive the movement of the second locking tongue 31. That is, the two-way linkage lock 100 of the embodiment of the present application can simultaneously control the movement of the first locking tongue 22 and the second locking tongue 31 through a lock head 21, so that the locking or unlocking action can be completed synchronously at multiple points, the operation is simple, and the locking or unlocking efficiency is improved.

In at least one embodiment, referring to FIG. 1, the two-way linkage lock 100 may further include a limiting assembly 40. The number of the limiting assembly 40 may be one or more, and the present application does not impose any limitation thereto. Each limiting assembly 40 includes at least one first fastener 41 and at least one opening 110 provided on the connecting rod 10, and one of the at least one opening 110 corresponds to one of the at least one first fastener 41. The first fastener 41 is fixed to the object to be locked, and the first fastener 41 extends through the opening 110. The first fastener 41 may be, but is not limited to, a screw. Through the cooperation between the first fastener 41 and the opening 110, the limiting assembly 40 can limit the movement of the connecting rod 10 in any direction, so that the connecting rod 10 can only move along its extension direction, thereby ensuring the stability of the connecting rod 10 when moving.

In at least one embodiment, each of the at least one opening 110 may penetrate the connecting rod 10 along a thickness direction of the connecting rod 10, and a plurality of openings 110 may be arranged at intervals along the extension direction of the connecting rod 10. Each of the plurality of openings 110 may be, but is not limited to, a waist-shaped hole. Each of the plurality of openings 110 is defined by an end surface, a connecting surface, another end surface, and another connecting surface connected end to end in sequence. The end surfaces are an arc surface and opposite to each other, and the connecting surfaces are parallel plane and opposite to each other. An arrangement direction of the two arc surfaces (that is, an extension direction of the parallel plane) is the extension direction of the connecting rod 10. When the connecting rod 10 moves under the drive of the first locking tongue 22, the first fastener 41 extending through the opening 110 can limit a random shaking of the connecting rod 10, and the waist-shaped opening 110 can ensure that the connecting rod 10 moves along the extension direction of the parallel plane of the opening 110, that is, ensure that the connecting rod 10 can only move along the extension direction of the connecting rod 10.

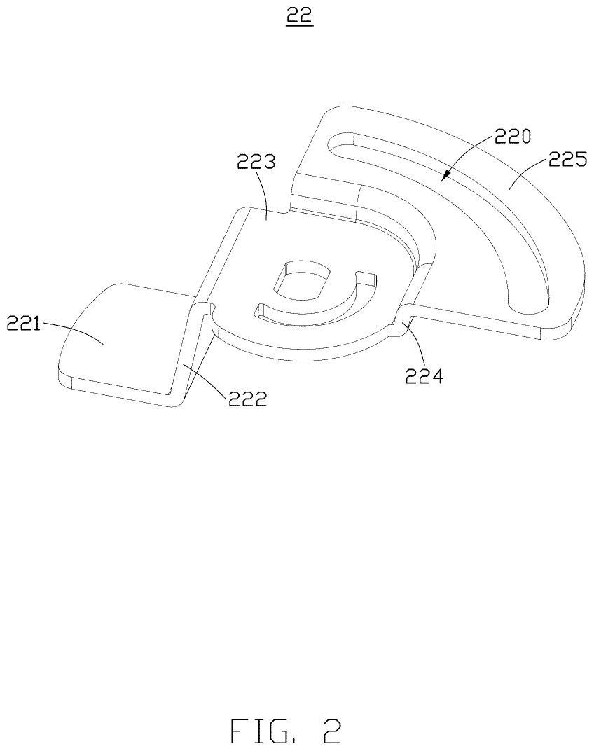

In at least one embodiment, referring to FIG. 2, the first locking tongue 22 may include a first protruding portion 221, a first inclined portion 222, a first connecting portion 223, a second inclined portion 224 and a second protruding portion 225 connected in sequence. The first protruding portion 221 may be in a shape of a thin sheet, which can be used to extend into or withdraw from the object to be locked, thereby achieving locking or unlocking. A main plane of the first protruding portion 221 (a surface perpendicular to the thickness direction of the first locking tongue 22, i.e., an upper surface or a lower surface of the first protruding portion 221 in FIG. 2) may be roughly parallel to a main plane of the connecting rod 10 (a surface perpendicular to the thickness direction of the connecting rod 10, i.e., an upper surface or a lower surface of the connecting rod 10 in FIG. 1), and the first protruding portion 221 may protrude from a surface of the first inclined portion 222 along a direction away from the second locking tongue 31. The first inclined portion 222 extends obliquely and has an angle with the first protruding portion 221. The angle may be an acute angle, a right angle or an obtuse angle, but the angle of the angle cannot be 0° or 180°. The first connecting portion 223 is sleeved on an outer circumference of the lock head 21, so as to fix the first locking tongue 22 on the lock head 21. The second inclined portion 224 extends obliquely and has an angle with the first connecting portion 223. The angle may be an acute angle, a right angle or an obtuse angle, but the angle cannot be 0° or 180°. The second protruding portion 225 is used to connect the connecting rod 10, and the sliding groove 220 is provided on the second protruding portion 225. The second protruding portion 225 can protrude from a surface of the second inclined portion 224 along a direction close to the second locking tongue 31.

In at least one embodiment, the sliding groove 220 may penetrate the second protruding portion 225 along a thickness direction of the second protruding portion 225, and the sliding groove 220 may be an arc-shaped sliding groove.

It can be understood that due to the inclined extension of the first inclined portion 222 and the second inclined portion 224, the main planes of the first protruding portion 221, the first connecting portion 223 and the second protruding portion 225 are not on the same horizontal line. Along a height direction of the lock head 21 (that is, the thickness direction of the connecting rod 10), the second protruding portion 225 is the highest (closest to the connecting rod 10), the first connecting portion 223 is the second, and the first protruding portion 221 is the lowest (farthest from the connecting rod 10).

In at least one embodiment, referring to FIG. 2, the second locking assembly 30 may further include a second fastener 32. The second fastener 32 is used to fix the second locking tongue 31 to the connecting rod 10, and the second fastener 32 may be, but is not limited to, a rivet.

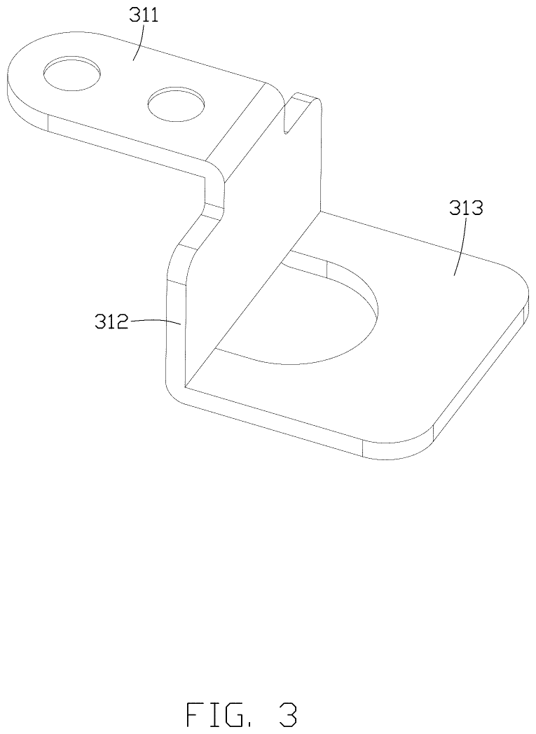

In at least one embodiment, referring to FIG. 3, the second locking tongue 31 may include a second connecting portion 311, a third connecting portion 312 and a third protruding portion 313 which are connected in sequence. The second connecting portion 311 is fixed to the connecting rod 10 by the second fastener 32, so that the second locking tongue 31 is fixed to the connecting rod 10 as a whole. The second connecting portion 311 may be in a shape of a thin sheet, and a main plane of the second connecting portion 311 (a surface perpendicular to a thickness direction of the second locking tongue 31, i.e., an upper surface or a lower surface of the second connecting portion 311 in FIG. 3) may be parallel to the main plane of the connecting rod 10 (a surface perpendicular to the thickness direction of the connecting rod 10, i.e., the upper surface or the lower surface of the connecting rod 10 in FIG. 1 ). The third connecting portion 312 is connected to one end of the second connecting portion 311 and extends in a direction away from the connecting rod 10 (i.e., extends in a downward direction in FIG. 3), and the third connecting portion 312 may be substantially perpendicular to the connecting rod 10 or the second connecting portion 311. The third protruding portion 313 is connected to one end of the third connecting portion 312 away from the second connecting portion 311 (or the connecting rod 10), and protrudes from a surface of the third connecting portion 312 in a direction away from the first locking assembly 20. The third protruding portion 313 is used to extend into or withdraw from the object to be locked, thereby achieving locking or unlocking.

Referring to FIG. 3, a cross-section of a structure formed by the second connecting portion 311 and the third connecting portion 312 may be in a shape of a 7, and a cross-section of a structure formed by the third connecting portion 312 and the third protruding portion 313 may be in a shape of a L.

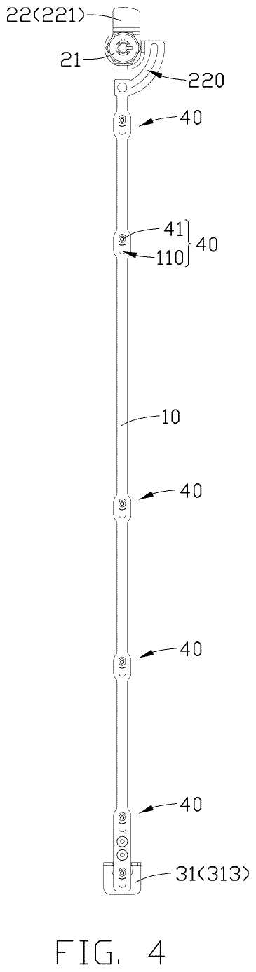

In at least one embodiment, referring to FIG. 4, the two-way linkage lock 100 has a locked state, and the lock head 21 can be rotated to switch the two-way linkage lock 100 to the locked state. For example, the lock head 21 can be rotated counterclockwise, and the first locking tongue 22 will rotate with the lock head 21, a rotation of the first locking tongue 22 will drive the connecting rod 10 to move away from the lock head 21 along the extension direction of the connecting rod 10 (that is, the connecting rod 10 moves downward to a state shown in FIG. 4), so that the first protruding portion 221 of the first locking tongue 22 and the third protruding portion 313 of the second locking tongue 31 respectively extend into the object to be locked, so that the two-way linkage lock 100 is switched to the locked state.

When the two-way linkage lock 100 is in the locked state, the main plane of the first protruding portion 221 is parallel to the main plane of the connecting rod 10, the first fastener 41 of the limiting assembly 40 may contact the arc-shaped end surface of the opening 110 that is closer to the lock head 21, and a distance between the second locking tongue 31 and the lock head 21 is the farthest at this time.

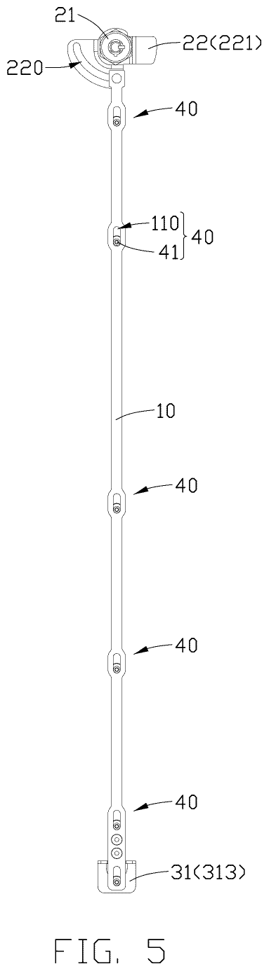

In at least one embodiment, referring to FIG. 5, the two-way linkage lock 100 also has an unlocked state, and the lock head 21 can be rotated to switch the two-way linkage lock 100 to the unlocked state. For example, the lock head 21 can be rotated clockwise, and the first locking tongue 22 will rotate with the lock head 21, the rotation of the first locking tongue 22 will drive the connecting rod 10 to move close to the lock head 21 along the extension direction of the connecting rod 10 (that is, the connecting rod 10 moves upward to a state shown in FIG. 5), so that the first protruding portion 221 of the first locking tongue 22 and the third protruding portion 313 of the second locking tongue 31 withdraw from the locked object respectively, so that the two-way linkage lock 100 is switched to the unlocked state.

When the two-way linkage lock 100 is in the unlocked state, the main plane of the first protruding portion 221 is substantially perpendicular to the main plane of the connecting rod 10, and the first fastener 41 of the limiting assembly 40 can contact the arc-shaped end surface of the opening 110 that is closer to the second locking tongue 31, and the distance between the second locking tongue 31 and the lock head 21 is the shortest at this time.

FIG. 6 illustrates an embodiment of a device 200. The device 200 includes an object 201 and the above two-way linkage lock 100. The two-way linkage lock 100 is used to lock or unlock the object 201.

In the above two-way linkage lock 100, the connecting rod 10 movably connected to the first locking tongue 22 is provided (the connecting rod 10 is movably connected to the first locking tongue 22 through the sliding groove 220 and the connecting pin 11), and the second locking tongue 31 is provided on the connecting rod 10, so that the rotation of the first locking tongue 22 can drive the connecting rod 10 to move, and the movement of the connecting rod 10 can drive the second locking tongue 31 to move, so that only one lock head 21 can simultaneously control the movement of the first locking tongue 22 and the second locking tongue 31, so that the locking or unlocking action can be completed synchronously at multiple points, the operation is simple, and the locking or unlocking efficiency is improved.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A two-way linkage lock comprising:
a connecting rod extending in an extension direction;
a first locking assembly located at an end of the connecting rod; and
a second locking assembly;
wherein a connecting pin is provided at the end of the connecting rod, the first locking assembly comprises a lock head and a first locking tongue sleeved on the lock head, the lock head drives the first locking tongue to rotate, and the first locking tongue comprises a sliding groove penetrating the first locking tongue, and the connecting pin extends through the sliding groove and is slidably arranged along the sliding groove, thereby driving the connecting rod to move along the extension direction of the connecting rod; the second locking assembly comprises a second locking tongue, the second locking tongue is fixed to an end of the connecting rod away from the first locking assembly.

2. The two-way linkage lock of claim 1, further comprising a limiting assembly, wherein the limiting assembly comprises a first fastener and an opening defined by the connecting rod, the first fastener is configured to be fixed to an object to be locked, and the first fastener extends through the opening.

3. The two-way linkage lock of claim 2, wherein the opening is a waist-shaped hole.

4. The two-way linkage lock of claim 1, wherein the first locking tongue comprises a first protruding portion, a first inclined portion, a first connecting portion, a second inclined portion, and a second protruding portion connected in sequence, the first protruding portion is configured to extend into or withdraw from an object to be locked to achieve locking or unlocking, the first inclined portion extends obliquely from the first protruding portion and has an angle with the first protruding portion, the first connecting portion is sleeved on an outer circumference of the lock head, the second inclined portion extends obliquely from the first connecting portion and has an angle with the first connecting portion, the second protruding portion is configured to connect the connecting rod, the sliding groove is defined by the second protruding portion.

5. The two-way linkage lock of claim 4, wherein the sliding groove penetrates the second protruding portion along a thickness direction of the second protruding portion, the sliding groove is an arc-shaped sliding groove.

6. The two-way linkage lock of claim 4, wherein the two-way linkage lock has a locked state, and a main surface of the first protruding portion is parallel to a main plane of the connecting rod when the two-way linkage lock is in the locked state.

7. The two-way linkage lock of claim 4, wherein the two-way linkage lock has an unlocked state, and a main surface of the first protruding portion is perpendicular to a main plane of the connecting rod when the two-way linkage lock is in the unlocked state.

8. The two-way linkage lock of claim 1, wherein the second locking assembly further comprises a second fastener, the second fastener is configured to fix the second locking tongue to the connecting rod.

9. The two-way linkage lock of claim 8, wherein the second locking tongue comprises a second connecting portion, a third connecting portion and a third protruding portion which are connected in sequence, the second connecting portion is fixed to the connecting rod by the second fastener, the third connecting portion is connected to an end of the second connecting portion and extends in a direction away from the connecting rod, the third protruding portion is connected to an end of the third connecting portion away from the second connecting portion, and the third protruding portion is configured to extend into or withdraw from an object to be locked to achieve locking or unlocking.

10. The two-way linkage lock of claim 9, wherein a cross-section of a structure formed by the third connecting portion and the third protruding portion is in a shape of a “L”.

11. A device comprising:
a two-way linkage lock for locking or unlocking an object, and the two-way linkage lock comprising:
a connecting rod extending in an extension direction;
a first locking assembly located at an end of the connecting rod; and
a second locking assembly;
wherein a connecting pin is provided at the end of the connecting rod, the first locking assembly comprises a lock head and a first locking tongue sleeved on the lock head, the lock head drives the first locking tongue to rotate, and the first locking tongue comprises a sliding groove penetrating the first locking tongue, and the connecting pin extends through the sliding groove and is slidably arranged along the sliding groove, thereby driving the connecting rod to move along the extension direction of the connecting rod; the second locking assembly comprises a second locking tongue, the second locking tongue is fixed to an end of the connecting rod away from the first locking assembly.

12. The device of claim 11, wherein the two-way linkage lock further comprises a limiting assembly, the limiting assembly comprises a first fastener and an opening defined by the connecting rod, the first fastener is configured to be fixed to the object, and the first fastener extends through the opening.

13. The device of claim 12, wherein the opening is a waist-shaped hole.

14. The device of claim 11, wherein the first locking tongue comprises a first protruding portion, a first inclined portion, a first connecting portion, a second inclined portion, and a second protruding portion connected in sequence, the first protruding portion is configured to extend into or withdraw from the object to achieve locking or unlocking, the first inclined portion extends obliquely from the first protruding portion and has an angle with the first protruding portion, the first connecting portion is sleeved on an outer circumference of the lock head, the second inclined portion extends obliquely from the first connecting portion and has an angle with the first connecting portion, the second protruding portion is configured to connect the connecting rod, the sliding groove is defined by the second protruding portion.

15. The device of claim 14, wherein the sliding groove penetrates the second protruding portion along a thickness direction of the second protruding portion, the sliding groove is an arc-shaped sliding groove.

16. The device of claim 14, wherein the two-way linkage lock has a locked state, and a main surface of the first protruding portion is parallel to a main plane of the connecting rod when the two-way linkage lock is in the locked state.

17. The device of claim 14, wherein the two-way linkage lock has an unlocked state, and a main surface of the first protruding portion is perpendicular to a main plane of the connecting rod when the two-way linkage lock is in the unlocked state.

18. The device of claim 11, wherein the second locking assembly further comprises a second fastener, the second fastener is configured to fix the second locking tongue to the connecting rod.

19. The device of claim 18, wherein the second locking tongue comprises a second connecting portion, a third connecting portion and a third protruding portion which are connected in sequence, the second connecting portion is fixed to the connecting rod by the second fastener, the third connecting portion is connected to an end of the second connecting portion and extends in a direction away from the connecting rod, the third protruding portion is connected to an end of the third connecting portion away from the second connecting portion, and the third protruding portion is configured to extend into or withdraw from an object to be locked to achieve locking or unlocking.

20. The device of claim 19, wherein a cross-section of a structure formed by the third connecting portion and the third protruding portion is in a shape of an L.
